(19) United States
(12) Patent Application Publication
(10) Pub. No.: US 2017/0158291 A1
(43) Pub. Date: Jun. 8, 2017

(54) CORNER PANEL FOR ULTRA-LOW TEMPERATURE FLUID STORAGE TANK, AND ULTRA-LOW TEMPERATURE FLUID THERMAL INSULATION SYSTEM HAVING SAME

(71) Applicant: DAEWOO SHIPBUILDING & MARINE ENGINEERING CO., LTD., Seoul (KR)

(72) Inventor: Haeng Sung HEO, Seoul (KR)

(73) Assignee: DAEWOO SHIPBUILDING & MARINE ENGINEERING CO., LTD., Seoul (KR)

(21) Appl. No.: 15/316,471

(22) PCT Filed: Apr. 28, 2015
(86) PCT No.: PCT/KR2015/004250

§ 371 Date: Dec. 5, 2016

(30) Foreign Application Priority Data
Jun. 3, 2014 (KR) 10-2014-0067594

(51) Int. Cl. B63B 25/16; F17C 3/02

(52) U.S. Cl. CPC B63B 25/16; F17C 3/02; F17C 2221/033; F17C 2270/0105; F17C 2203/0636

(57) ABSTRACT

A corner panel for an ultra-low temperature fluid storage tank is disclosed. The corner panel for an ultra-low temperature fluid storage tank comprises: a panel main body installed on the corner of the storage tank and having an L-shape; an anchor strip fixed on the panel main body; and a steel corner fixed on the anchor strip and installed on the corner of the panel main body, and fixed by welding a membrane of a metal material.

### FIELD

The present invention relates to a corner panel for ultra-low temperature fluid storage tanks, and, more particularly, to a corner panel for ultra-low temperature fluid storage tanks which allows a metallic membrane to be effectively attached thereto at low cost and can reduce the amount of metal used in manufacture thereof, and an ultra-low temperature fluid insulation system including the same.

### BACKGROUND ART

Generally, natural gas is transported through an onshore or offshore gas pipe line in a gaseous state, or transported to remote sources of demand by an LNG carrier in the form of liquefied natural gas (hereinafter, ‘LNG’). LNG is obtained by cooling natural gas to an extremely low temperature of about −163° C. and is suitable for long-distance transportation by sea since LNG has a volume of about 1/600 that of natural gas in a gaseous state.

An LNG Carrier (LNGC) carrying LNG to an onshore source of demand or an LNG regasification vessel (RV) carrying LNG to an onshore source of demand, regasifying LNG into natural gas, and offloading the natural gas is provided with an LNG storage tank (also referred to as ‘cargo tank’) designed to withstand ultra-low temperature of LNG. Recently, there is increasing demand for a floating offshore structure such as an LNG FPSO (floating, production, storage and offloading) or an LNG FSRU (floating storage and regasification unit), which is also provided with an LNG storage tank.

The LNG storage tank is divided into an independent-type and a membrane-type depending upon whether the weight of cargo is directly applied to a thermal insulation material. Typically, the independent-type storage tank is divided into a MOSS-type and an IHI-SPB-type, and the membrane-type storage tank is divided into a GTT NO 96-type and a TGZ Mark III-type. Such GTT and TGZ-type tanks are disclosed in U.S. Pat. No. 6,035,795, U.S. Pat. No. 6,378,722, U.S. Pat. No. 5,586,513, U.S. Patent Publication No. 2003-0000949, Korean Patent Publication No. 10-2000-0011347, and Korean Patent Publication No. 10-2000-0011346. In addition, the independent-type storage tank is disclosed in Korean Patent Publication No. 10-0015063, Korean Patent Publication No. 10-0305513, and the like.

A typical membrane type LNG storage tank is provided with a double barrier to secure safety. A primary barrier of the double barrier is formed of metal such as SUS304 or invar, and a secondary barrier is formed of metal such as SUS304 or invar and triplex.

FIG. 1 is a perspective view of a typical primary corner panel.

Referring to FIG. 1, a typical primary corner panel 10 may be used for, for example, a TGZ Mark III-type tank and has a structure in which plywood panels 11 are placed at right angles to each other with a polyurethane packing 12 interposed therebetween, a corner member 13 formed of stainless steel is attached to an inner surface of each corner of the plywood panels 11, and a stud 13a of the corner member 13 is received by a through-hole 11a of each of the plywood panels 11.

The corner member 13 of the typical primary corner panel 10 is formed of stainless steel to allow a metallic primary membrane to be welded thereto and is fixedly assembled to the thick plywood panel 11 supporting the bottom of the corner member through the stud 13a.

However, such a typical primary corner panel has problems of difficulty in attaching a secondary membrane and secondary corner panel, both of which are formed of metal, thereto, increase in weight and cost due to excessive use of metal, and increase in man hour due to a need to upturn the corner panel in assembly with the stud.

In addition, one example of a corner structure of an LNG storage tank is disclosed in Korean Patent No. 10-0499709. The corner structure of an LNG storage tank includes a secondary insulation wall having an L shape to adjoin each corner at which inner surfaces of a hull of an LNG carrier join in a face-to-face manner, a secondary sealing wall formed on an upper surface of the secondary insulation wall, and a primary insulation wall formed on an upper surface of the secondary sealing wall, wherein the primary insulation wall is provided on an upper surface thereof with an L-shaped metallic corner support to bear unsymmetrical load of a storage tank. Here, the corner support is supported by upper and lower support rods extending through the primary and secondary insulation walls and the secondary sealing wall and being mechanically secured to each other.

However, such a typical corner structure of an LNG storage tank has problems in that assembly of the corner structure is costly in terms of time and effort due to inevitable increase in man hour in assembly of the upper and lower rods and there is a limitation in reduction of weight.

### DISCLOSURE

### [Technical Problem]

Embodiments of the present invention have been conceived to solve such a problem in the art and provide a corner panel for ultra-low temperature fluid storage tanks, which allows a metallic membrane to be effectively attached thereto at low cost, can reduce the amount of metal used in manufacture thereof to reduce weight and costs, and thus can be used as a primary corner panel which is lighter and allows a secondary membrane to be more easily attached thereto.

### [Technical Solution]

In accordance with one aspect of the present invention, there is provided a corner panel for ultra-low temperature fluid storage tanks, including: a panel main body placed at a corner of the storage tank and having an L shape; an anchor strip secured to the panel main body; and a steel corner secured to the anchor strip to be placed at a corner of the panel main body and allowing a metallic membrane to be welded thereto.

An upper portion of the panel main body may be formed of plywood.

The anchor strip may be secured to the plywood through a rivet.

The anchor strip may include a pair of anchor strips secured to both sides of the corner of the panel main body in parallel to each other with the corner of the panel main body interposed therebetween.

The steel corner may have an L shape so as to be welded to the anchor strip along the corner of the panel main body.

The steel corner may be secured to the anchor strip to be placed at one side of the anchor strip in a longitudinal direction of the anchor strip such that the other side of the anchor strip can be exposed.

The corner panel may further include an additional anchor strip secured to a portion of the panel main body and allowing a metallic membrane to be welded thereto.

The additional anchor strip may be secured to plywood forming an upper portion of the panel main body through a rivet.

The additional anchor strip may be placed on each surface of the panel main body to extend in a direction perpendicular to the corner of the panel main body.

In accordance with another aspect of the present invention, there is provided a corner panel for ultra-low temperature fluid storage tanks, including: a panel main body placed at a corner of the storage tank; and an anchor strip secured to the panel main body and configured to allow a steel corner to be fixed thereto, wherein the steel corner is allowing a metallic membrane to be welded thereto.

The anchor strip may be secured to plywood forming an upper portion of the panel main body through a rivet.

The steel corner may be welded to the anchor strip.

In accordance with a further aspect of the present invention, there is provided a thermal insulation system including the corner panel for ultra-low temperature fluid storage tanks according to one or another aspect of the present invention.

### [Advantageous Effects]

Embodiments of the present invention provide a corner panel for ultra-low temperature fluid storage tanks, which allows a metallic membrane to be effectively attached thereto at low cost, can reduce the amount of metal used in manufacture thereof to reduce weight and costs, and allows both a unit product and a storage tank to be more easily manufactured due to light-weight thereof, thereby reducing man hour.

### DESCRIPTION OF DRAWINGS

FIG. 1 is a perspective view of a typical primary corner panel.

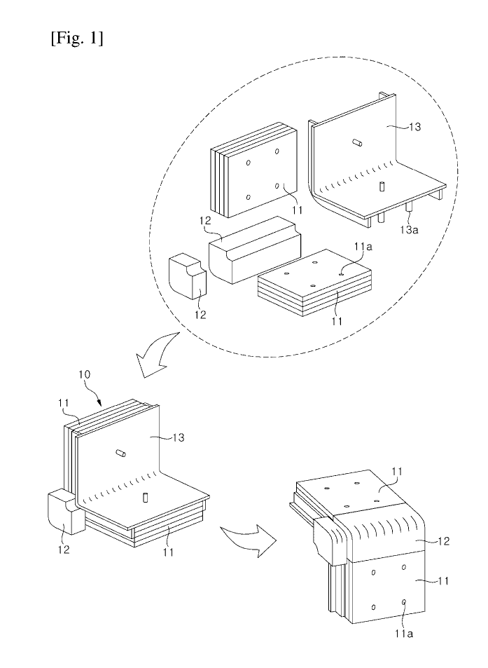

FIG. 2 is a perspective view of a corner panel for ultra-low temperature fluid storage tanks according to one exemplary embodiment of the present invention.

### MODE

Hereinafter, exemplary embodiments of the present invention will be described in more detail with reference to the accompanying drawings. However, it should be understood that these examples are provided for illustration only and are not to be construed in any way as limiting the present invention.

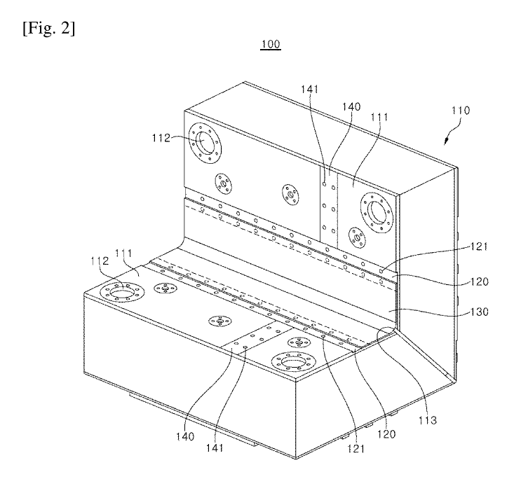

FIG. 2 is a perspective view of a corner panel for ultra-low temperature fluid storage tanks according to one exemplary embodiment of the present invention.

Referring to FIG. 2, a corner panel 100 for an ultra-low temperature fluid storage tank according to the exemplary embodiment includes a panel main body 110 placed at a corner of a storage tank, and an anchor strip 120 secured to the panel main body 110, and may further include a steel corner 130 secured to the anchor strip 120.

The corner panel 100 for an ultra-low temperature fluid storage tank according to the exemplary embodiment may be, for example, a secondary corner panel of a thermal insulation system of an ultra-low temperature fluid storage tank which secondarily insulates an ultra-low temperature fluid and is configured to allow a secondary membrane, corresponding to a secondary sealing wall secondarily preventing leakage of the ultra-low temperature fluid, to be secured to an upper portion thereof. However, it should be understood that other implementations are also possible and the corner panel may be a primary corner panel primarily preventing leakage of the ultra-low temperature and allowing a primary membrane, corresponding to a primary sealing wall primarily preventing leakage of the ultra-low temperature fluid, to be secured to an upper portion thereof. Here, the primary membrane or the secondary membrane is formed of metal.

The panel main body 110 is placed at the corner of the storage tank to be located at a junction of a bottom surface of a hull and a bulkhead or to be located on another corner panel, and may have an L shape so as to be in close contact with the corner. The panel main body 110 may be formed of various insulating materials for thermal insulation of the ultra-low temperature fluid. For example, an upper portion of the panel main body may be formed of plywood 111, and alternatively, the upper and lower portions of the panel main body may be formed of plywood, wherein an insulating material fills a space between upper plywood and lower plywood or is disposed between the upper plywood and lower plywood. As another example, the panel main body may have a structure in which plywood and an insulating material are stacked one above another. As a further example, the panel main body may have a structure in which a plywood box is filled with an insulating material. In addition, the panel main body 110 may have a hole 112 into which a fastening member is inserted to fix the panel main body to the hull or the like.

The anchor strip 120 is secured to a portion of the panel main body 110, for example, to the upper plywood 111 of the panel main body 110 through a rivet 121. Here, the rivet 121 may include a plurality of rivets.

The anchor strip 120 may have a plate structure and may have various shapes having a size corresponding to a portion of the panel main body 110. In addition, the anchor strip may be placed on the panel main body 110 in various ways such that the steel corner 130 can be secured to the panel main body 110 through the anchor strip. For example, a pair of anchor strips may be secured to both sides of the corner 113 of the panel main body 110 in parallel to each other with the corner 113 interposed therebetween.

The steel corner 130 is secured to the anchor strip 120 so as to be placed at the corner 113 of the panel main body 110 and is formed of a metal to allow a metallic membrane to be welded thereto. The steel corner 130 may have an L shape so as to be welded to the metallic anchor strip 120 along the corner 113 of the panel main body 110. Here, the steel corner 130 may be secured to the anchor strip 120 so as to be placed at one side of the anchor strip in the longitudinal direction of the anchor strip such that the other side of the anchor strip can be exposed. In this way, the other side of the anchor strip 120 is exposed outside the steel corner 130, thereby providing a site to which the metallic membrane can be secured by welding.

An additional anchor strip 140 may be secured to an upper side of the panel main body 110. The additional anchor strip 140 is a metallic plate and may be secured to a portion of the panel main body 110 so as to allow a metallic membrane to be welded thereto. In addition, the additional anchor strip 140 may be secured to plywood 111 forming an upper portion of the panel main body 110 through a rivet 141, and may be placed on each surface of the panel main body 110 to extend in a direction perpendicular to the corner 113 so as to allow the metallic membrane to be easily secured thereto, as described herein. For example, the additional anchor strip may extend at a right angle to the anchor strip 120. Here, the rivet 121 for securing the additional anchor strip 140 may include a plurality of rivets.

In accordance with another aspect of the present invention, a thermal insulation system of an ultra-low temperature fluid storage tank includes a corner panel, wherein the cornel panel may be the corner panel 100 for an ultra-low temperature fluid storage tank as set forth above. Since details of the corner panel are the same as described above, description thereof will be omitted.

The thermal insulation system of an ultra-low temperature fluid storage tank may have a structure in which primary and secondary sealing walls primarily and secondarily preventing leakage of an ultra-low temperature fluid such as LNG, respectively, and insulation layers primarily and secondarily insulating LNG, respectively, are alternately stacked one above another. The primary or secondary sealing wall may be formed of an SUS304 or invar membrane; the primary and secondary insulation layers may be formed of a combination of various insulation materials such as a plywood panel or box, polyurethane, glass wool, and perlite; and the primary insulation layer and/or the secondary insulation layer may have the corner panel 100 for an ultra-low temperature fluid storage tank according to one exemplary embodiment of the present invention.

The corner panel for ultra-low temperature fluid storage tanks according to the present invention and the thermal insulation system including the same allow a metallic membrane to be effectively attached thereto at low cost, can reduce the amount of metal used in manufacture thereof to reduce weight and costs, and allows both a unit product and a storage tank to be more easily manufactured due to light weight thereof, thereby reducing man hour.

Although some exemplary embodiments have been described herein, it should be understood that these embodiments are provided for illustration and are not to be construed in any way as limiting the present invention, and that various modifications, changes, alterations, and equivalent embodiments can be made by those skilled in the art without departing from the spirit and scope of the invention.

1. A corner panel for ultra-low temperature fluid storage tanks, comprising:
a panel main body placed at a corner of the storage tank and having an L shape;
an anchor strip secured to the panel main body; and
a steel corner secured to the anchor strip to be placed at a corner of the panel main body and allowing a metallic membrane to be welded thereto.

2. The corner panel according to claim 1, wherein an upper portion of the panel main body is formed of plywood.

3. The corner panel according to claim 2, wherein the anchor strip is secured to the plywood through a rivet.

4. The corner panel according to claim 1, wherein the anchor strip comprises a pair of anchor strips secured to both sides of the corner of the panel main body in parallel to each other with the corner of the panel main body interposed therebetween.

5. The corner panel according to claim 4, wherein the steel corner has an L shape so as to be welded to the anchor strip along the corner of the panel main body.

6. The corner panel according to claim 5, wherein the steel corner is secured to the anchor strip to be placed at one side of the anchor strip in a longitudinal direction of the anchor strip such that the other side of the anchor strip can be exposed.

7. The corner panel according to claim 1, further comprising: an additional anchor strip secured to a portion of the panel main body and allowing a metallic membrane to be welded thereto.

8. The corner panel according to claim 7, wherein the additional anchor strip is secured to plywood forming an upper portion of the panel main body through a rivet.

9. The corner panel according to claim 7, wherein the additional anchor strip is placed on each surface of the panel main body to extend in a direction perpendicular to the corner of the panel main body.

10. A corner panel for ultra-low temperature fluid storage tanks, comprising:
a panel main body placed at a corner of the storage tank; and an anchor strip secured to the panel main body and configured to allow a steel corner to be fixed thereto, wherein the steel corner is allowing a metallic membrane to be welded thereto.

11. The corner panel according to claim 10, wherein the anchor strip is secured to plywood forming an upper portion of the panel main body through a rivet.

12. The corner panel according to claim 10, wherein the steel corner is welded to the anchor strip.

13. A thermal insulation system comprising the corner panel for ultra-low temperature fluid storage tanks according to claim 1.
